(19) United States
(12) Patent Application Publication
(10) Pub. No.: US 2004/0155894 A1
(43) Pub. Date: Aug. 12, 2004

(54) Image processing unit for and method of processing pixels and image display apparatus comprising such an image processing unit

(76) Inventor: Roy Van Dijk, Eindhoven (NL)

Correspondence Address: Philips Electronics North America Corporation, Corporate Patent Counsel, PO Box 3001, Briarcliff Manor, NY, 10510, US

(21) Appl. No.: 10/480,666

(22) PCT Filed: Jun. 20, 2002
(86) PCT No.: PCT/IB02/02385

(30) Foreign Application Priority Data
Jun. 21, 2001 (EP) 01202410.5
Nov. 29, 2001 (EP) 01204609.0

(51) Int. Cl. G09G 5/10

(52) U.S. Cl. 345/692; 345/60

(57) ABSTRACT

The image processing unit (603) for processing pixels of an image to be displayed on a display panel (702) in a plurality of sub-fields is designed to perform motion compensation. The motion compensation is executed in two parts which can be divided in a number of steps. In a pre-compensation part (816) optimal sub-field combinations are determined for the pixels of the image, i.e. which sub-field pixels should be on and which should be off. Motion vectors are used for this. The pre-compensation part is essential to compensate for errors which are inherent with the second part (818): shifting sub-field pixels with a discrete number of pixel positions (322) although the actual translation (308) is unequal to the extent of that discrete number of pixel positions (322).

The invention relates to an image processing unit for processing pixels of an image to be displayed on a display panel in a plurality of sub-fields, each of the sub-fields having a respective weight corresponding with a respective intensity level generated in this sub-field, the image processing unit comprising a motion compensation unit designed to assign a value of a particular sub-field of a first pixel to a second pixel based on a first motion vector of the first pixel and on a first time difference between a first time of the particular sub-field and a reference time.

The invention further relates to a method of processing pixels of an image to be displayed on a display panel in a plurality of sub-fields, each of the sub-fields having a respective weight corresponding with a respective intensity level generated in this sub-field, the image processing method comprising a motion compensation step of assigning a value of a particular sub-field of a first pixel to a second pixel based on a first motion vector of the first pixel and on a first time difference between a first time of the particular sub-field and a reference time.

The invention further relates to an image display apparatus for displaying a series of images, comprising:

receiving means for receiving a signal representing the series of images;

an image processing unit for processing pixels of an image to be displayed on a display panel in a plurality of sub-fields, each of the sub-fields having a respective weight corresponding with a respective intensity level generated in this sub-field, the image processing unit comprising a motion compensation unit designed to assign a value of a particular sub-field of a first pixel to a second pixel based on a first motion vector of the first pixel and on a first time difference. between a first time of the particular sub-field and a reference time; and

the display panel for displaying the series of images.

A method of the kind described in the opening paragraph is known from the article “Motion Compensation in Plasma Displays”, by R. van Dijk and T. Holtslag in Proceedings of The Fifth International Display Workshops, IDW 1998, pages 543-546. In this article it is described that on current plasma display panels, disturbing motion artifacts are perceived as dynamic false colors or pseudo-color appearances due to sub-field illumination scaling. The article summarizes many solutions that have been proposed to reduce these artifacts, for instance changing the order of displayed sub-fields; applying bit or sub-field splitting to divide major sub-fields; and scattering false colors by multiple sub-fields with equal illumination levels in which the same illumination levels are generated by different combinations of these sub-fields. None of these methods eliminate the basic cause of the problem. They only try to mask the effect in areas with a small spatial luminance gradient. The article provides an analysis of the problem of motion artifacts. The motion artifact itself is due to the tracking of motion by the observer's eyes and the time difference between the various sub-fields that are displayed. Due to the tracking of motion, various sub-fields that ought to be perceived at one position of the eye are perceived at different positions, and the different sub-fields of nearby pixels are accumulated at the same position on the retina and contribute to the illumination level that is perceived instead of the intended one. When an observer focuses on a moving object, he will start tracking the movement. The object is kept at exactly one position on the retina. Due to the speed, \vec{v}=(vₓ, v_{y}), of this object, a certain distance is traveled while following this object for a certain period. When this same object is observed on a plasma display panel, the positions seen are determined by the starting position, \vec{x}=(x, y), of this object and the time difference, Δtₙ, of the observed sub-field, SFₙ(\vec{x}). The observed luminance at this position, L(\vec{x}), when this motion is being tracked by the observer, is determined by the observed positions on the screen. This depends on whether or not sub-field SFₙ(\vec{x}) at position \vec{x}, is on, and on the illumination level Wₙ of this sub-field:

$$L ( \vec{x} ) = {\sum }_{n = 1}^{N} {SF}_{n} ( \vec{x} + \vec{v} \cdot Δ {t}_{n} ) \cdot {W}_{n} \qquad ( 1 )$$

with Δtₙ=tₙ−t₀, the time difference between sub-field n and the reference time t₀, and the speed \vec{v} expressed in pixels per field period.

The article “Motion Compensation in Plasma Displays” also provides a solution for the problem of motion artifacts: motion compensation. Motion compensation can reduce dynamic false contouring and pseudo-color appearance without reduction in sharpness or loss of detail. Motion compensation attempts to position the sub-field values of that one pixel, i.e. portion of an image, that is being tracked exactly at the positions on the display panel that are observed at the time of the sub-fields and at the position that is seen. It can be inferred from Equation 1 that a spatial offset of \vec{d}ₙ=(dxₙ, dyₙ), must be given to each sub-field SFₙ(\vec{x}), to be able to place these sub-fields at the correct positions, resulting in a luminance:

$$L ( \vec{x} ) = {\sum }_{n = 1}^{N} {SF}_{n} ( \vec{x} + \vec{v} \cdot Δ {t}_{n} - {\vec{d}}_{n} ) \cdot {W}_{n} \qquad ( 2 )$$

In order to avoid artifacts dₙ is chosen to be:

\vec{d}ₙ=\vec{v}·Δtₙ−\vec{d}ₙ^{e} (3)

with \vec{d}ₙ=(dxₙ, dyₙ) the displacement in the horizontal and the vertical directions, which is rounded to integer values, and \vec{d}ₙ^{e}=(dxₙ^{e}, dyₙ^{e}) the rounding error. A sub-field must be displaced over an integer number of pixels, i.e. cells of the display panel, because no parts of a cell can be switched on or off. For a particular pixel, the cell is switched on or off. It is not possible to switch on the cell for a fraction to account for the fact that the corrected position does not fully coincide with this particular pixel. It is a disadvantage that as a result the motion is not completely compensated for, but a residual error remains. Hence still some motion artifacts as mentioned above like dynamic false colors or pseudo-color appearances are perceived.

It is a first object of the invention to provide an image processing unit of the kind described in the opening paragraph with an improved reduction of motion artifacts.

It is a second object of the invention to provide a method of the kind described in the opening paragraph with reduced motion artifacts.

It is a third object of the invention to provide an image display apparatus of the kind described in the opening paragraph with an improved reduction of motion artifacts.

The first object of the invention is achieved in that the image processing unit further comprises:

a first intensity calculating means for calculating a contribution of a current sub-field to the first pixel on the basis of the first motion vector and the weight of the current sub-field; and

a decision means for deciding whether the first pixel is to be ignited in the current sub-field on the basis of a target intensity level and the contribution of the current sub-field. By determining the level of intensity that is already realized for the first pixel in earlier processed sub-fields and with knowledge about which sub-fields still have to be processed, the image processing unit according to the invention makes a reliable and robust decision as to whether or not the first pixel must be ignited in the current sub-field. Rounding errors in previous sub-fields are taken into account by looking back and establishing in which sub-fields particular sub-fields have actually been ignited. Amongst others, the invention is based on the insight that every sub-field provides a new chance to select a possible combination of sub-fields to be processed such that the desired intensity level is approached as close as possible.

In the article “Optimally Reducing Motion Artifacts in Plasma Displays”, by M. A. Klompenhouwer and G. de Haan, SID 2000, pages 388-391 an other method is described for motion compensation that inherently avoids rounding errors. In this article it is described that for each pixel in a sub-field the luminance is calculated that is “seen” for the current sub-field pixel calculated along the motion vector for all previous processed sub-fields. A sub-field pixel is a temporal spatial object corresponding to a pixel position in a sub-field. On the basis of these sub-field interpolations and the interpolated luminance that must be made on that motion vector, it is decided whether the current sub-field pixel should be switched on. The luminance that must be made is the interpolation of the luminance at a position determined by a motion vector at the reference time. This is done for all pixels in the display for each successive sub-field. The order of the calculations is from left to right and from top to bottom and starting at the highest illumination level. The number of sub-field interpolations required for a particular sub-field is dependent on the amount of sub-fields that have already been built up. A disadvantage of this method is the amount of processing operations, e.g. interpolations and memory accesses, that are required to calculate the motion compensated sub-fields of one image. In the image processing unit according to the prior art the number of sub-field interpolations required for a particular sub-field is independent on the amount of sub-fields that have already been built up.

An embodiment of the image processing unit according to the invention further comprises:

a first storing means for storing a desired intensity level of the first pixel;

a second intensity calculating means for calculating an accumulated intensity level based on earlier processed sub-fields, if any; and

a third intensity calculating means for calculating the target intensity level to be generated in the current and subsequent sub-fields, if any, on the basis of the accumulated intensity level and the desired intensity level. The first storing means and the third intensity calculating means may have been combined into one count down means, which stores the target intensity level. This does not effect the principle of the invention.

An embodiment of the image processing unit according to the invention is arranged to process the sub-fields in order of decreasing weight of the sub-fields. By processing in order of decreasing sub-field weights, the desired intensity level can easily be reached without running the risk of an overshoot in a certain sub-field which cannot be corrected in sub-fields to be processed later.

An embodiment of the image processing unit according to the invention is arranged to process only a portion of the sub-fields. The image processing unit is flexible in that it has to process not all sub-fields, but only the most important ones. It can apply the process of decision making only for the highest sub-fields. If the highest sub-fields have been processed, then the target intensity that remains can be clipped to values between 0 and the sum of the sub-field weights that are not processed yet and use a Look-Up-Table to assign the clipped target intensity to the remaining lower sub-fields. This reduces the required processing capacity but still improves the moving image quality, especially for bright areas. It is also possible to apply the decision process only for the sub-fields which are probably required for the desired intensity level. That means e.g. that for low desired intensity levels the sub-fields with the highest weights can be skipped. And only for sub-fields with lower weights the contribution must be calculated.

In an embodiment of the image processing unit according to the invention, the first intensity calculating means is arranged to calculate the contribution of the current sub-field to the first pixel by determining a pixel coverage of the first pixel based on:

a first offset between a distance in first direction and a rounded distance in first direction, with the distance in first direction based on a second motion vector of the first pixel and on a second time difference between a current time of the current sub-field and the reference time; and

a second offset between a distance in second direction and a rounded distance in second direction, with the distance in second direction based on the second motion vector of the first pixel and on the second time difference between the current time of the current sub-field and the reference time, the first direction cross to the second direction. A first direction might be substantially horizontal and a second direction might be substantially vertical or vice versa. A sub-field pixel does not only contribute to its reference pixel, but also to neighboring pixels of the reference pixel. The reference pixel might corresponds with the origin of the motion vector, i.e. the particular pixel. To correct for the residual error the contributions of the sub-field pixel to reference pixels have to be calculated. A contribution is based on a coverage and the sub-field weight. Based on contributions it is to be decided whether a particular sub-field pixel should be on or off.

In an embodiment of the image processing unit according to the invention, the first intensity calculating means is arranged to determine the pixel coverage of the first pixel by means of a Look-Up Table. The pixel coverage is based on two values: a horizontal offset and a vertical offset. These values are in a known domain. Without much loss of accuracy these values can be truncated to a limited set of values which form the entries of a LUT. The advantage of the LUT is a reduction of required processing capacity. It is also possible to define a LUT which incorporates the various weights of the sub-fields as extra entry. With such a LUT a contribution can be calculated directly.

In an embodiment of the image processing unit according to the invention, the decision means is arranged to take into account decisions made for neighboring pixels. If one cell of a display panel emits less light than desired, then this can be compensated partly by emission of too much light by the neighboring cells. However this compensation is limited. The image processing unit is arranged to prevent pixel-on pixel-off combinations. In other words it is preferred that neighboring cells emit substantially mutual equal amounts of light in the case of homogeneous regions in the image.

An embodiment of the image processing unit according to the invention is characterized in that the image processing unit is designed to take into account constraints related to simultaneously addressing neighboring pixels of the display panel with equal data.

In the article “Address Time reduction in PDPs by means of Partial Line Doubling” by J. Hoppenbrouwers et al., in SID 2001, a technique, called Partial Line Doubling (PLD), is described. This technique enables to reduce the total time required for addressing a Plasma Display Panel (PDP), thus being able to increase the total sustain time and thus peak brightness of the PDP. The idea is to address two adjacent lines simultaneously with the same data (“line doubling”), but only for the least significant sub-fields (hence “partial”). Hence, there are constraints related to sub-fields for these neighboring pixels. If a particular pixel is turned on for a particular sub-field then a neighboring pixel must also be turned on for that particular sub-field. In general, the decision whether the first pixel is to be ignited in the current sub-field is not only based on the target intensity level and the contribution of the current sub-field being calculated for that first pixel. The decision can also depend on similar values being calculated for neighboring pixels which will be addressed simultaneously. As long as sub-fields are considered which are not addressed simultaneously the decision does not depend on the latter values. Several embodiments of the image processing unit according to the invention are possible to take into account these constraints. The various intensity calculating means, the storing means and the decision means can be adapted to perform their tasks for multiple pixels or additional means of the mentioned types are included. However the principle of decision based on contribution of the current sub-field remains the same. The extra aspect is that a decision for a particular pixel has direct consequences for a neighboring pixel. In the article “Application of Partial Line Doubling for Duplicated Subfield Schemes” by R. van Woudenberg et al. in proceedings IDW 2001, it is disclosed that various types of partial line doubling are possible. Neighboring pixels can be connected but optionally there are other pixels located between two neighboring pixels. Besides that it is disclosed that multiple groups of dependent and/or independent sub-fields can be defined, e.g. a first group of independent sub-fields comprising the most significant sub-fields, a second group of independent sub-fields comprising the least significant sub-fields and a third group of dependent sub-fields comprising the remaining sub-fields.

In an embodiment of the image processing unit according to the invention, the decision means is arranged to select a sub-field combination out of a set of possible sub-field combinations in order to decide whether the first pixel is to be ignited in the current sub-field. It might be possible to create a predetermined intensity level with several sub-field combinations. There are several reasons for having sets of possible sub-field combinations: e.g. to reduce large area flicker, or to reduce the sensitivity for errors in the motion vector field. By being able to select a preferred sub-field combination out of a set of possible combinations these type of errors are reduced.

The second object of the invention is achieved in that the image processing method further comprises:

a first intensity calculating step of calculating a contribution of a current sub-field to the first pixel on the basis of the first motion vector and the weight of the current sub-field; and

a decision step of deciding whether the first pixel is to be ignited in the current sub-field on the basis of a target intensity level and the contribution of the current sub-field.

The third object of the invention is achieved in that the image processing unit further comprises:

a first intensity calculating means for calculating a contribution of a current sub-field to the first pixel on the basis of the first motion vector and the weight of the current sub-field; and

a decision means for deciding whether the first pixel is to be ignited in the current sub-field on the basis of a target intensity level and the contribution of the current sub-field.

These and other aspects of the image processing unit, the image display apparatus and the image processing method according to the invention will become apparent from and will be elucidated with respect to the implementations and embodiments described hereinafter and with reference to the accompanying drawings, wherein:

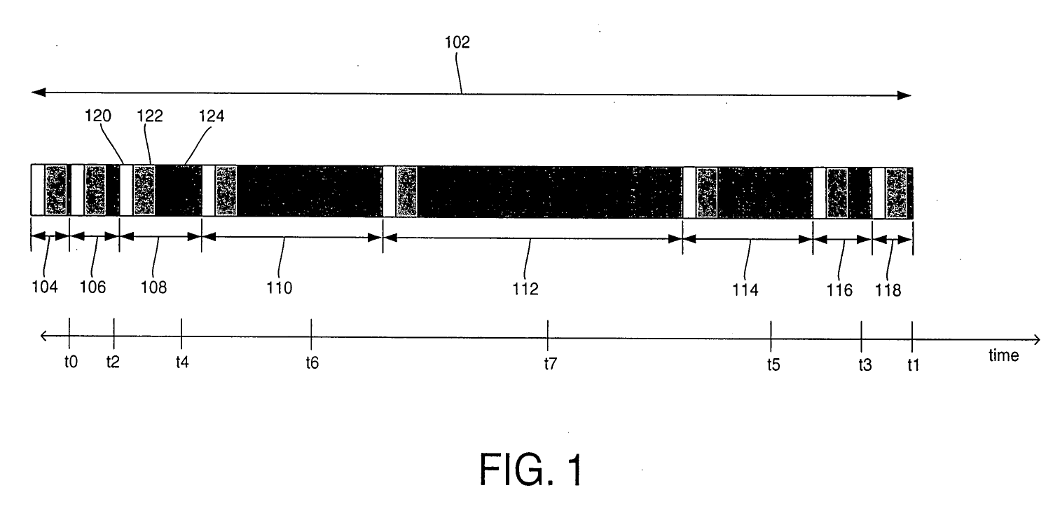

FIG. 1 schematically shows a field period with 8 sub-fields;

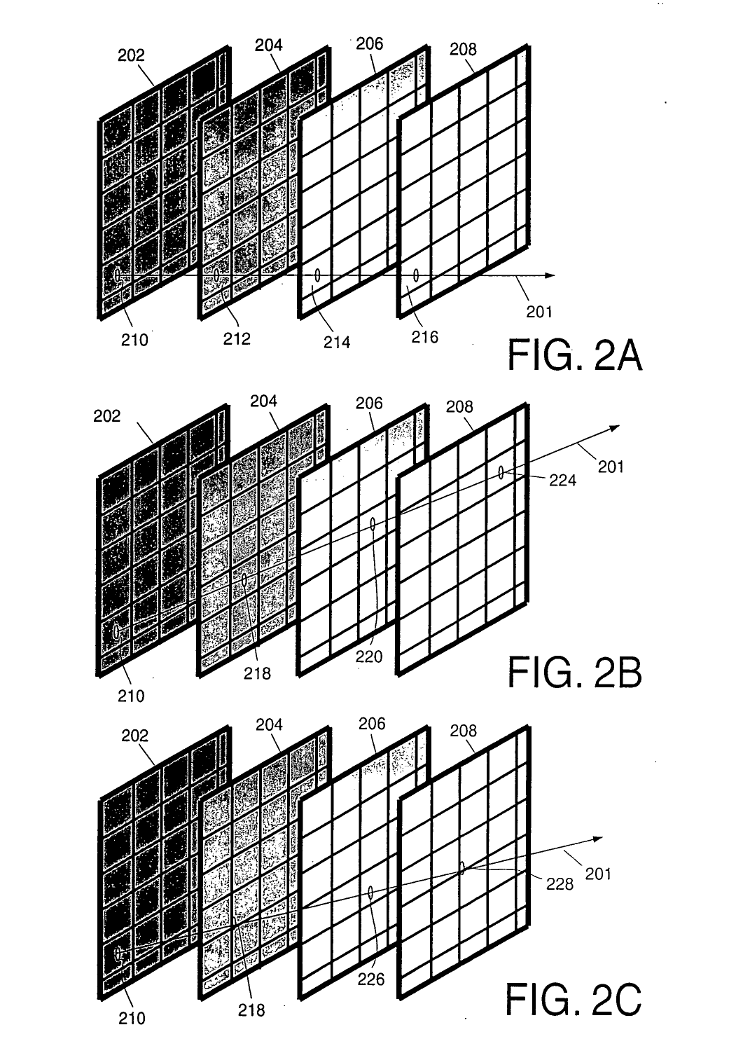

FIG. 2A schematically shows sub-field pixels located on a motion vector, with mutual equal coordinates;

FIG. 2B schematically shows sub-field pixels located on a motion vector, with the motion vector crossing through the centers of the sub-field pixels;

FIG. 2C schematically shows sub-field pixels located on a motion vector, with the motion vector not crossing through the centers of the sub-field pixels;

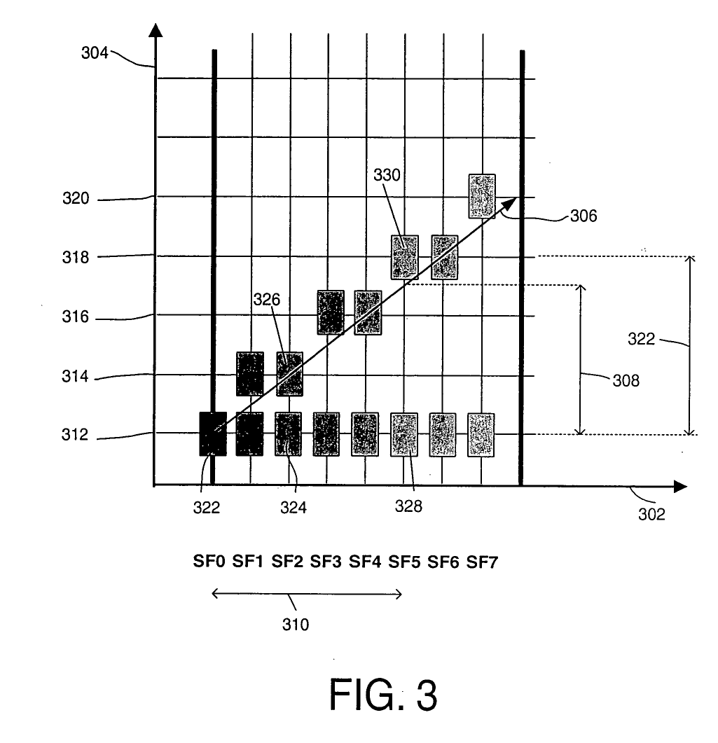

FIG. 3 schematically shows the concept of motion compensation based on shifting sub-field values, according to the prior art;

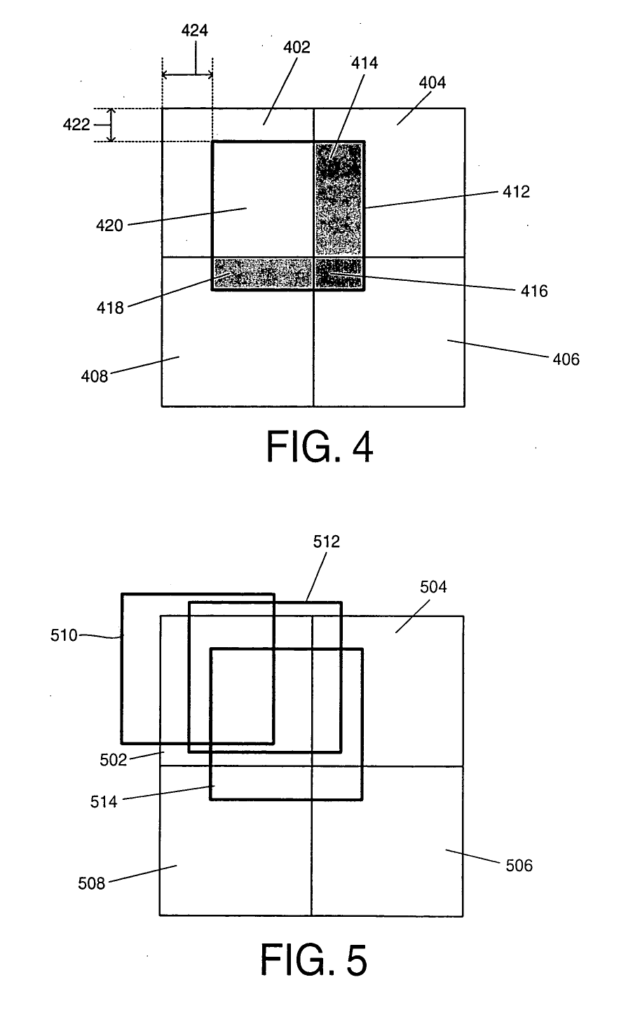

FIG. 4 schematically shows the contribution of a sub-field pixel to four reference pixels, according to the invention;

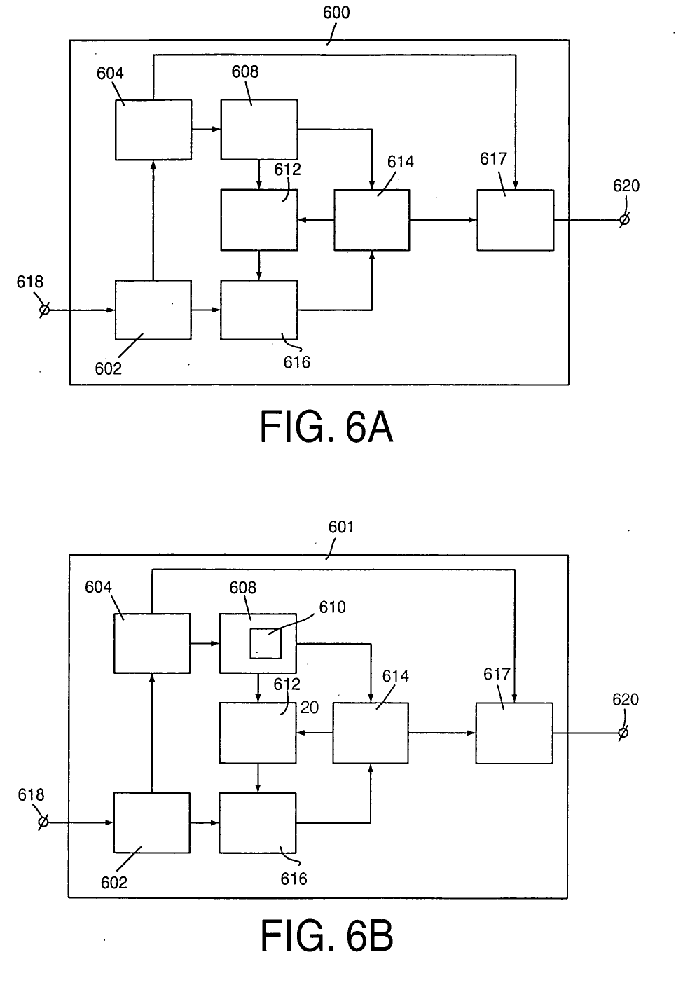

FIG. 5 schematically shows the contribution of three sub-field pixels to a particular reference pixel;

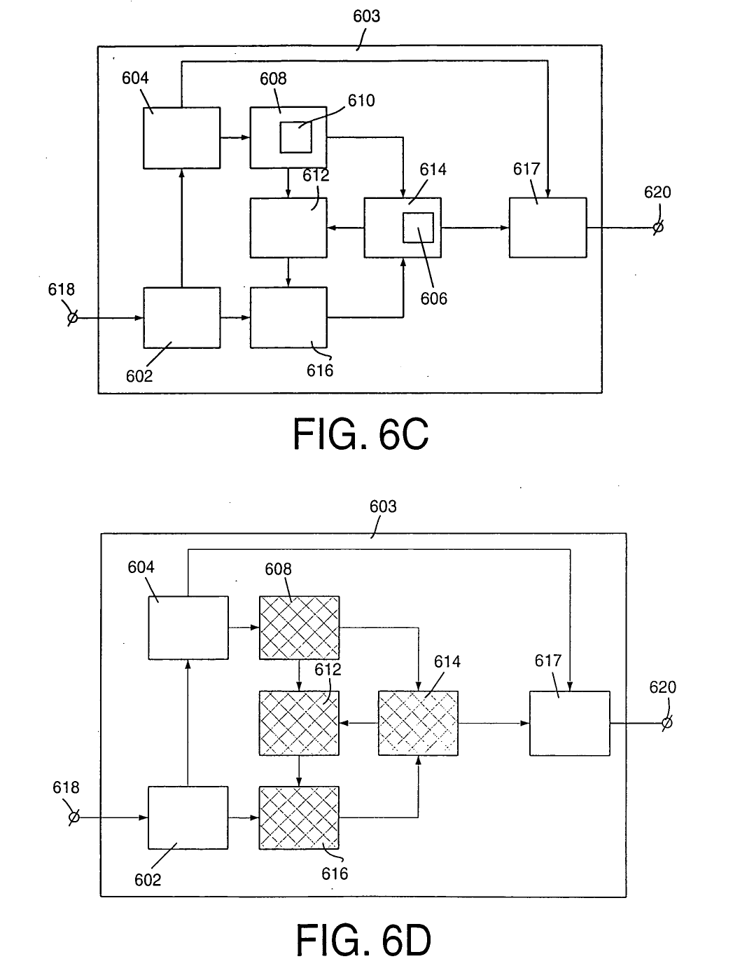

FIG. 6A schematically shows an image processing unit;

FIG. 6B schematically shows an image processing unit comprising a LUT for the determination of the coverage;

FIG. 6C schematically shows an image processing unit arranged to select a sub-field combination out of a set of possible sub-field combinations;

FIG. 6D schematically shows an image processing unit arranged to take into account constraints related to simultaneously addressing neighboring pixels of the display panel with equal data;

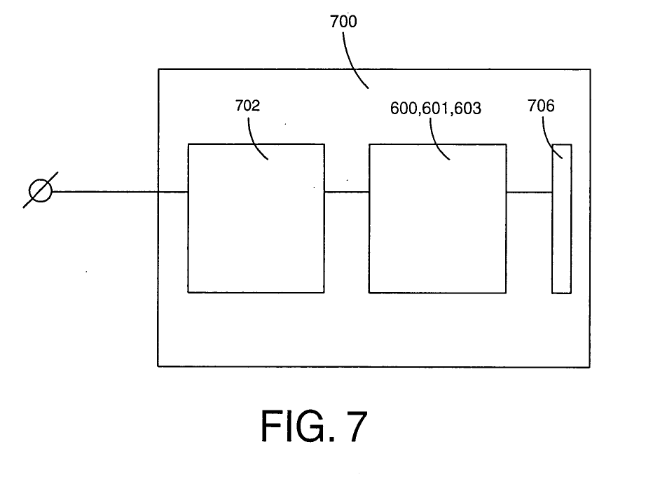

FIG. 7 shows elements of an image display apparatus; and

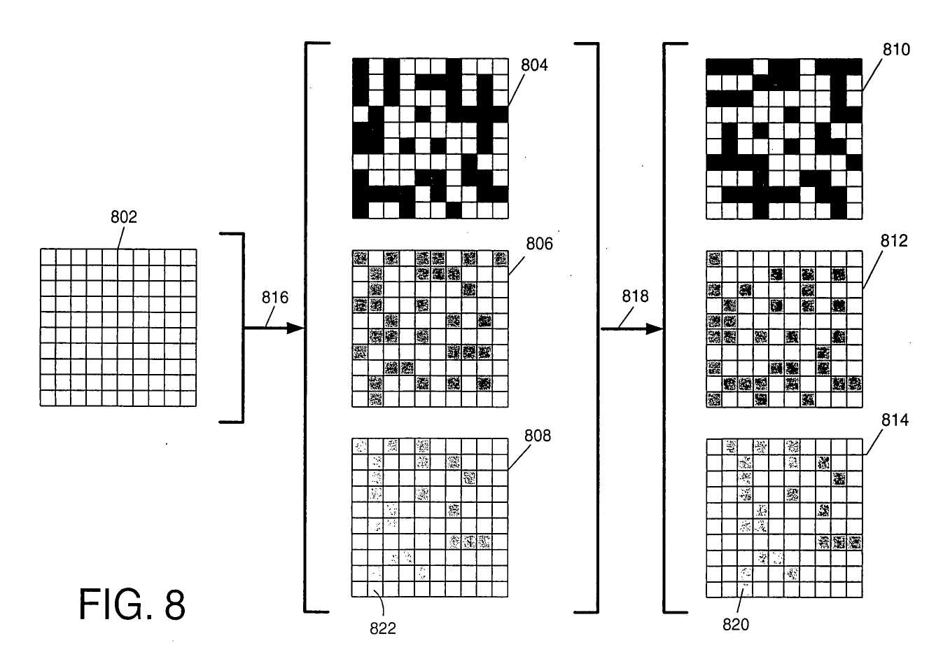

FIG. 8 schematically shows two parts of motion compensation.

Corresponding reference numerals have the same meaning.

FIG. 1 schematically shows a field period 102 with 8 sub-fields. Field period 102 is the period in which a single image is displayed on the display panel. In this example, the field period 102 consists of 8 sub-fields 104-118. In a sub-field, e.g. 108, a cell of the display panel may be switched on in order to produce an amount of light. Each sub-field 104-118 starts with an erasure phase e.g. 120 in which the memories of all cells are simultaneously erased. The next phase in the sub-field is the addressing phase e.g. 122 in which the cells that are to be switched on for emitting light are conditioned. Then, in a third phase 124 of the sub-fields, which is called the sustain phase, sustain pulses are applied to the cells. This causes the cells that have been addressed, to emit light during this third phase. The organization of these phases is shown in FIG. 1, where time runs from left to right. Moments of time t0-t7 for the various sub-fields are also indicated. Hence in this example sub-field 0 is the first sub field, succeeded by sub-fields 2, 4, 6, 7, 5, 3 respectively 1. It is to be noted that in some display panels the sub-field ends with the erasure phase, rather than starting with it. The erasure phase may also be absent for some sub-field schemes. However this is of no significance to the invention which can be applied in either case.

FIG. 2A shows four matrices 202-208 of sub-field pixels. A sub-field pixel is a temporal spatial object corresponding to a pixel position in a sub-field. Each element of such a matrix 202-208 corresponds to a sub-field pixel 210-216. A sub-field pixel can have one out of two values: on or off. The observed luminance is determined by the values of the sub-field pixels 210-216. This means that the corresponding cell is on respectively off in the sub-field period. FIG. 2A schematically shows sub-field pixels 210-216 located on a motion vector 201 which is equal to zero, i.e. no movement. The coordinates of these sub-fields pixels 210-216 are mutually equal.

FIG. 2B schematically shows sub-field pixels 210, 218, 220 and 224 located on a motion vector 201 which is unequal to zero. The motion vector 201 crosses the sub-field pixels 210, 218, 220 and 224 through the centers of these sub-field pixels. The observed luminance at a position, when motion is being tracked by the observer, is determined by the observed positions on the screen: sub-field pixels 210, 218, 220 and 224. In this case motion can be fully compensated by applying integer shifts. This means assignment of a value of a particular sub-field of a first pixel to a second pixel based on the motion vector 201 of the first pixel and on a first time difference between the particular sub-field, e.g. 204, and a reference sub-field, e.g. 202. See also FIG. 3 for an explanation of motion compensation based on shifting. The effect of the assignment is that the value of the particular sub-field of the first pixel determines whether the cell of the display panel corresponding to the second pixel will emit light or not in the particular sub-field.

FIG. 2C schematically shows sub-field pixels 210, 218, 226 and 228 located on a motion vector 201. The motion vector 201 does not cross the sub-field pixels 210, 218, 226 and 228 through the centers of these sub-field pixels. In this case motion can only be partly compensated by applying integer shifts. There remains a residual error. This is caused by the fact that sub-field pixels 210, 218, 226 and 228 contribute not only to their reference pixels, but also to neighboring pixels of the reference pixels. A reference pixel corresponds with the origin of the motion vector. To correct for the residual error the contribution of the various sub-field pixels to the reference pixels have to be calculated. Based on the contributions it is to be decided whether a particular sub-field pixel should be on or off.

FIG. 3 schematically shows the concept of motion compensation based on shifting values of sub-field pixels 322-330. This is according to the prior art. On the x-axis 302 the parameter time is indicated. Moments of time SF0-SF7 for the various sub-fields are indicated on the x-axis 302. The y-axis 304 indicates the positions 312-320 of sub-field pixels. The motion vector 306 represents the motion of a particular pixel, i.e. portion of an image as function of time. Position 312 corresponds with the reference position. Without motion all sub-field pixels of the particular pixel should be located on that position. To apply motion compensation, values of sub-field pixels are shifted: values of sub-field pixels are assigned to other sub-field pixels. E.g. the value of sub-field pixel 324 is shifted one pixel to location 314 and assigned to sub-field pixel 326. Sub-field pixel 326 and other sub-field pixels are also shifted. Sub-field pixel 328 is shifted 3 pixel positions to position 318. However this applied shift 322 is larger than the actual shift 308 as being derived from the motion vector 306 and the time difference 310 between SF5 and SF0. The effect of an incorrect shift is that on one side of the reference pixel to much light is generated and on the other side to little, which results in a bright respectively dark spot. Perhaps it would have been better if the sub-field pixel was not switched on.

FIG. 4 schematically shows the contribution of a sub-field pixel 412 to four reference pixels 402-408. The concept of contribution is a major aspect of the invention. The contribution is based on the horizontal offset 424, the vertical offset 422 and the weight of the sub-field. The horizontal offset 424 and the vertical offset 422 determine the coverage 420 of the sub-field pixel 412 related to the reference pixel 402. For neighboring reference pixels 404-408 the coverage 414,416 respectively 418 can be calculated accordingly.

FIG. 5 schematically shows the contribution of three sub-pixels 510-514 to a particular reference pixel 502. In FIG. 5 it can be seen that the horizontal offset and vertical offset differs per sub-field. The result is that the coverage is also different for the various sub-fields.

FIG. 6A schematically shows an image processing unit 600 according to the invention comprising:

a first storing means 602 for storing desired intensity levels of pixels. This storing means 602 is also arranged to receive the incoming signal which is provided at the input connector 618 of the image processing unit 600;

a motion estimator 604 arranged to calculate motion vectors for the pixels;

a first intensity calculating means 608 for calculating a contribution of a current sub-field to the first pixel on the basis of the first motion vector and the weight of the current sub-field;

a second intensity calculating means 612 for calculating an accumulated intensity level based on earlier processed sub-fields, if any;

a third intensity calculating means 616 for calculating a target intensity level to be generated in the current and subsequent sub-fields, if any, on the basis of the accumulated intensity level and the desired intensity level;

a decision means 614 for deciding whether the first pixel is to be ignited in the current sub-field on the basis of the target intensity level and the contribution of the current sub-field. Optionally the decision means 614 is arranged to take into account decisions made for neighboring pixels; and

a motion compensation unit 617 for assigning values of sub-field pixels to other sub-field pixels. In FIG. 3 the principle of this assignment unit 617 is disclosed.

The working of the image processing unit 600 will be described below by means of two examples which are illustrated with Tables 1 and 2. The sub-fields are processed in order of decreasing weight of the sub-fields. Tables 1 and 2 illustrate the various intensity levels as function of time for a particular pixel. In both Tables it is illustrated that the sub-fields are processed one after the other: Time 0,1,2, . . . 6. The second to the fifth column of Tables 1 and 2 indicate the various intensity levels: the desired, the contribution of the current sub-field, the accumulated, respectively the target intensity level of the next period. The last 6 columns of Tables 1 and 2 provides information about the sub-fields. The second row of these latter 6 columns provides the identifications of the sub-fields: SF1-SF6. The third row of these latter 6 columns provide the sub-field weights: 1,2, . . . 6. The fourth row of these latter 6 columns provide the values of the coverage. In Table 1 these values are all equal to 1. This means that there is no motion or an “integer” motion: See FIG. 2A respectively FIG. 2B. In Table 2 these values are all less then 1: See FIG. 2C. In both cases the desired intensity level of a particular pixel equals 12.

First the example of Table 1 will be described. On time =0, corresponding to the initial state, no sub-fields have been processed. On time =1 sub-field SF6 has been processed. Sub-field SF6 is the first sub-field because it has the highest sub-field weight. The contribution of sub-field SF6 is 6, i.e. the sub-field weight of SF6 multiplied by the coverage equals 6. The accumulated value has become 6, and there is still 6 to go, i.e. the target intensity equals 6. On time =2 sub-field SF5 has been processed. The contribution of sub-field SF5 is 5, i.e. the sub-field weight of SF5 multiplied by the coverage equals 5. The accumulated value has become 11, and there is still 1 to go, i.e. the target intensity equals 1. On time =3 sub-field SF4 has been processed. The contribution of sub-field SF4 is 4. This contribution is too much. And the decision unit decides that sub-field SF4 must be switched off for the particular sub-field pixel. This decision can only be made as long as it is still possible to reach the target intensity level. This depends on the sub-fields that are still to be processed. The accumulated value remains 11 and the target intensity remains 1. The process continues for the next subsequent sub-fields. Also sub-fields SF3 and SF2 will be switched off for the particular sub-field pixel. On time =6 sub-field SF1 has been processed. The contribution of sub-field SF1 is 1. The accumulated value has become 12, and the target intensity equals 0. The resulting sub-field combination of the particular pixel can be found in the last row of Table 1: “110001”. This word is input for the motion compensation unit 617. With this sub-field combination the desired amount of light can be generated.

TABLE 1

| | Intensity level | | | | Sub-fields | | | | | | |
|---|---|---|---|---|---|---|---|---|---|---|---|
| Time | Desired | Contribution | Accumulated | Target | SF1 | SF2 | SF3 | SF4 | SF5 | SF6 | |
| | | | | | 1 | 2 | 3 | 4 | 5 | 6 | Weight |
| | | | | | 1 | 1 | 1 | 1 | 1 | 1 | Coverage |
| 0 | 12 | 0 | 0 | 12 | 0 | 0 | 0 | 0 | 0 | 0 | |
| 1 | 12 | 6 | 6 | 6 | 0 | 0 | 0 | 0 | 0 | 1 | |
| 2 | 12 | 5 | 11 | 1 | 0 | 0 | 0 | 0 | 1 | 1 | |
| 3 | 12 | 4 | 11 | 1 | 0 | 0 | 0 | 0 | 1 | 1 | |
| 4 | 12 | 3 | 11 | 1 | 0 | 0 | 0 | 0 | 1 | 1 | |
| 5 | 12 | 2 | 11 | 1 | 0 | 0 | 0 | 0 | 1 | 1 | |
| 6 | 12 | 1 | 12 | 0 | 1 | 0 | 0 | 0 | 1 | 1 | |

Secondly the example of Table 2 will be described. On time =0 no sub-fields have been processed. On time =1 sub-field SF6 has been processed. The contribution of sub-field SF6 is 5.4, i.e. the sub-fields weight of SF6 multiplied by the coverage equals 5.4. The accumulated value has become 5.4, and there is still 6.6 to go, i.e. the target intensity equals 6.6. On time =2 sub-field SF5 has been processed. The contribution of sub-field SF5 is 3.5. The accumulated value has become 8.9, and the target intensity equals 3.1. On time =3, sub-field SF4 has been processed. The contribution of sub-field SF4 is 2. The accumulated value has become 10.9, and there is still 1.1 to go. On time =4 sub-field SF3 has been processed. The contribution of sub-field SF3 is 2.4. This contribution is too much. And the decision unit decides that sub-field SF3 must be switched off for the particular sub-field pixel. The accumulated value remains 10.9, and there is still 1.1 to go. The process continues for the subsequent sub-fields. Also sub-field SF1 will be switched off for the particular sub-field pixels. On time =6 all sub-fields have been processed. The accumulated value has become 12.1, and the target intensity equals −0.1. This means that a little bit too much light will be emitted for the particular pixel. The resulting sub-field combination of the particular pixel can be found in the last row of Table 2: “111010”. This word is input for the motion compensation unit 617. With this sub-field combination the desired amount of light can substantially be generated.

TABLE 2

| | Intensity level | | | | Sub-fields | | | | | | |
|---|---|---|---|---|---|---|---|---|---|---|---|
| Time | Desired | Contribution | Accumulated | Target | SF1 | SF2 | SF3 | SF4 | SF5 | SF6 | |
| | | | | | 1 | 2 | 3 | 4 | 5 | 6 | Weight |
| | | | | | 0.7 | 0.6 | 0.8 | 0.5 | 0.7 | 0.9 | Coverage |
| 0 | 12 | 0 | 0 | 12 | 0 | 0 | 0 | 0 | 0 | 0 | |
| 1 | 12 | 5.4 | 5.4 | 6.6 | 0 | 0 | 0 | 0 | 0 | 1 | |
| 2 | 12 | 3.5 | 8.9 | 3.1 | 0 | 0 | 0 | 0 | 1 | 1 | |
| 3 | 12 | 2 | 10.9 | 1.1 | 0 | 0 | 0 | 1 | 1 | 1 | |
| 4 | 12 | 2.4 | 10.9 | 1.1 | 0 | 0 | 0 | 1 | 1 | 1 | |
| 5 | 12 | 1.2 | 12.1 | −0.1 | 0 | 1 | 0 | 1 | 1 | 1 | |
| 6 | 12 | 0.7 | 12.1 | −0.1 | 0 | 1 | 0 | 1 | 1 | 1 | |

Tables 1 and 2 illustrate the intensity levels as function of time for a particular pixel. It is described that for each sub-field pixel it is decided to switch it on or off. This decision is based on the various intensity levels which are being calculated as intermediate results. In FIG. 4 and FIG. 5 it is described that a sub-field pixel might contribute to more than one reference pixel. The actual number of reference pixels to which a sub-field pixel contributes is determined by the horizontal offset and vertical offset. See the Table 3 below.

TABLE 3

| The number of reference | | |
|---|---|---|
| pixels to which a sub-field | If the horizontal | And if the vertical |
| pixel contributes is | offset is | offset is |
| 1 | equal to zero | equal to zero |
| 2 | unequal to zero | equal to zero |
| 2 | equal to zero | unequal to zero |
| 4 | unequal to zero | unequal to zero |

This means that when it is decided that a particular sub-field pixel is switched on also the various intensity levels of the neighboring pixels, which receive a contribution of the particular sub-field pixel must be updated. But also the decision itself is influenced by the various intensity levels of neighboring pixels. To make a decision it is required to minimize an error function with the following parameters:

the target intensities of reference pixels;

the contribution of the current sub-field;

sub-field weights of subsequent sub-fields that still need to be processed; and

decisions of already processed sub-field pixels;

FIG. 6B schematically shows an image processing unit 601 comprising a LUT 610, i.e. a Look-Up Table, for the determination of the coverage. The first intensity calculating means 608 comprises a Look-Up Table to determine the pixel coverage. An example of a Look-Up Table has two entries: the horizontal offset and the vertical offset. In Table 4 a portion of such a LUT is provided. The horizontal offset and the vertical offset are listed in the first respectively second column of the Table. The third column lists the output: the coverage. This Table corresponds with a correction accuracy of the rounding error of ¼ pixel. A correction accuracy of the rounding error of ⅛ pixel or higher is preferable.

TABLE 4

| | |
|---|---|
| Input | Output |

| Horizontal offset | Vertical offset | Coverage |
|---|---|---|
| 0 | 0 | 1 |
| 0.25 | 0 | 0.75 |
| 0.5 | 0 | 0.5 |
| 0.75 | 0 | 0.25 |
| 1 | 0 | 0 |
| 0 | 0.25 | 0.75 |
| 0.25 | 0.25 | 0.5625 |
| 0.5 | 0.25 | 0.375 |
| 0.75 | 0.25 | 0.1875 |
| 1 | 0.25 | 0 |
| . . . | . . . | . . . |
| . . . | . . . | . . . |

FIG. 6C schematically shows an image processing unit 603 arranged to select a sub-field combination out of a set of possible sub-field combinations. The decision means 614 is arranged to include knowledge of preferred sub-field combinations to decide whether the particular pixel is to be ignited in the current sub-field. This knowledge is stored in a Look-Up Table 606. In this Look-Up Table 606 can be found which sub-field combinations are possible to achieve a predetermined intensity level. Preferred combinations are be indicated. It might be that there are extra constraints, e.g. if some sub-fields have already been processed. An example to illustrate the data provided by such a Look-Up Table 606 is given in Table 5. In the first column the required intensity level is listed. In this context “required” means either “desired” or “target”. The second column indicates whether the combination is preferred or not with respectively a “1” and a “0”. The other columns indicate whether the corresponding sub-field should be on or off with respectively a “1” and a “0”.

TABLE 5

| Required | | | | | | | |
|---|---|---|---|---|---|---|---|
| intensity level | Preferred | Sub-field 1 | Sub-field 2 | Sub-field 3 | Sub-field 4 | Sub-field 5 | Sub-field 6 |
| 1 | 1 | 1 | 0 | 0 | 0 | 0 | 0 |
| 1 | 0 | 0 | 1 | 0 | 0 | 0 | 0 |
| 2 | 1 | 1 | 1 | 0 | 0 | 0 | 0 |
| 2 | 0 | 0 | 0 | 1 | 0 | 0 | 0 |
| 3 | 1 | 1 | 0 | 0 | 1 | 0 | 0 |
| 3 | 0 | 0 | 0 | 0 | 0 | 1 | 0 |
| 4 | 1 | 1 | 1 | 1 | 0 | 0 | 0 |
| 4 | 0 | 0 | 0 | 0 | 0 | 0 | 1 |
| 4 | 0 | 0 | 1 | 0 | 0 | 1 | 0 |
| . . . | . . . | . . . | . . . | . . . | . . . | . . . | . . . |

FIG. 6D schematically shows an image processing unit 605 arranged to take into account constraints related to simultaneously addressing neighboring pixels of the display panel with equal data. The main difference compared with the image processing unit 600 which is described in connection with FIG. 6A is that this image processing unit 605 comprises a decision means 614 for deciding whether multiple pixels are to be ignited in the current sub-field on the basis of multiple target intensity levels and the contribution of the current sub-field. In other words, the decision means 614 is arranged to take into account the consequences for neighboring pixels. Other differences are that the intensity calculating means 608, 612 and 616 are designed to calculate for more than 4 pixels the various contributions and levels: at least for 6 pixels or even 8 pixels.

The working of the image processing unit 605 will be described below by means of an example which is illustrated in Table 6A and Table 6B. This example looks similar to the example illustrated in Table 1. The main difference is that in this case for some sub-field pixels simultaneously the decision is made whether they must be switched on or off. In this embodiment only the three least significant sub-fields are dependent. Hence, it is not possible to switch on the first pixel during sub-field 1, 2 or 3 without switching on the second pixel and vice versa. However, for the three most significant sub-fields the decisions are made independently. To minimize errors the independence of these most significant sub-fields should be fully applied. For reasons of simplicity the coverage equals 1 for all sub-field pixels. The desired intensity for the first pixel equals 14 and for the second pixel 12.

On time =0, corresponding to the initial state, no sub-fields have been processed. On time =1 sub-field SF6 has been processed. Sub-field SF6 is the first sub-field because it has the highest sub-field weight. The contribution of sub-field SF6 is 6, i.e. the sub-field weight of SF6 multiplied by the coverage equals 6. The first pixel will be switched on for sub-field SF6. The accumulated value for the first pixel has become 6, and there is still 8 to go. However, the second pixel will not be switched on for sub-field SF6. The second target intensity-remains 12. On time =2 sub-field SF5 has been processed. It has been decided that both the first and second pixel have to be switched on for sub-field SF5. The first target intensity has become 3 and the second target intensity has become 7. On time =3 sub-field SF4 has been processed. Only the second pixel will be switched on, resulting in a target intensity of 3. The contribution of sub-field SF4 is too much for the first pixel. And the decision unit has decided for the first pixel that it will not be switched on for sub-field SF4. This decision can only be made as long as it is still possible to reach the target intensity level. This depends on the sub-fields that are still to be processed. The first accumulated value remains 11. The process continues for the next sub-fields. Also during sub-field SF3 both pixels will be switched off. On time =5 sub-field SF2 has been processed. The contribution of sub-field SF2 is 2. Both pixels will be switched on. The same holds for sub-field 1. The resulting sub-field combinations for the pixels can be found in the last row of Table 6A: “110011” and Table 6B “010011”. These words are input for the motion compensation unit 617. With these sub-field combinations appropriate amounts of light can be generated by the two pixels. This example shows that by choosing different subfield values for the most significant sub-fields for both pixels correct amounts of light can be emitted.

TABLE 6A

| | Intensity level | | | | Sub-fields | | | | | | |
|---|---|---|---|---|---|---|---|---|---|---|---|
| Time | Desired | Contribution | Accumulated | Target | SF1 | SF2 | SF3 | SF4 | SF5 | SF6 | |
| | 1^{st} | 1^{st} | 1^{st} | 1^{st} | 1 | 2 | 3 | 4 | 5 | 6 | Weight |
| | | | | | 1 | 1 | 1 | 1 | 1 | 1 | Coverage |
| 0 | 14 | 0 | 0 | 14 | 0 | 0 | 0 | 0 | 0 | 0 | |
| 1 | 14 | 6 | 6 | 8 | 0 | 0 | 0 | 0 | 0 | 1 | |
| 2 | 14 | 5 | 11 | 3 | 0 | 0 | 0 | 0 | 1 | 1 | |
| 3 | 14 | 4 | 11 | 3 | 0 | 0 | 0 | 0 | 1 | 1 | |
| 4 | 14 | 3 | 11 | 3 | 0 | 0 | 0 | 0 | 1 | 1 | |
| 5 | 14 | 2 | 13 | 1 | 0 | 1 | 0 | 0 | 1 | 1 | |
| 6 | 14 | 1 | 14 | 0 | 1 | 1 | 0 | 0 | 1 | 1 | |

TABLE 6B

| | Intensity level | | | | Sub-fields | | | | | | |
|---|---|---|---|---|---|---|---|---|---|---|---|
| Time | Desired | Contribution | Accumulated | Target | SF1 | SF2 | SF3 | SF4 | SF5 | SF6 | |
| | 2^{nd} | 2^{nd} | 2^{nd} | 2^{nd} | 1 | 2 | 3 | 4 | 5 | 6 | Weight |
| | | | | | 1 | 1 | 1 | 1 | 1 | 1 | Coverage |
| 0 | 12 | 0 | 0 | 12 | 0 | 0 | 0 | 0 | 0 | 0 | |
| 1 | 12 | 6 | 0 | 12 | 0 | 0 | 0 | 0 | 0 | 0 | |
| 2 | 12 | 5 | 5 | 7 | 0 | 0 | 0 | 0 | 1 | 0 | |
| 3 | 12 | 4 | 9 | 3 | 0 | 0 | 0 | 1 | 1 | 0 | |
| 4 | 12 | 3 | 9 | 3 | 0 | 0 | 0 | 0 | 1 | 0 | |
| 5 | 12 | 2 | 11 | 1 | 0 | 1 | 0 | 0 | 1 | 0 | |
| 6 | 12 | 1 | 12 | 0 | 1 | 1 | 0 | 0 | 1 | 0 | |

FIG. 7 shows elements of an image display apparatus 700 according to the invention. The image display apparatus 700 has a receiving means 702 for receiving a signal representing the image to be displayed. The signal may be a broadcast signal received via an antenna or cable but may also be a signal from a storage device like a VCR (Video Cassette Recorder) or Digital Versatile Disk (DVD). The image display apparatus 700 further has an image processing unit 600,601,603 for processing the image and a display panel 706 for displaying the processed image. The display panel 706 is of a type that is driven in sub-fields. The image processing unit 600,601,603 is implemented as described in connection with FIG. 6A, 6B or 6C.

FIG. 8 schematically shows two parts 816, 818 of motion compensation, performed by the image processing unit 600, 601, 603 as described in FIG. 6A, 6B or 6C:

In the “pre-correction part” 816 the values of the sub-field pixels are determined for an image 802. In other words, for each pixel the appropriate sub-field combination is determined. The “pre-correction part” comprises the steps as described in connection with FIG. 6A, 6B and 6C. The result of this “pre-correction part” are 2-Dimensional arrays 804-808 storing the values of sub-field pixels of the various sub-fields.

In the “shift part” 818, the values of sub-field pixels are assigned to other sub-field pixels. E.g. the value of sub-field pixel 822 is shifted one pixel position and assigned to sub-field pixel 820. The “shift part” is described in FIG. 3.

Several processing sequences are possible. This is related with the available memory to store intermediate results. E.g. it is possible

to pre-correct an entire image 802 and to store the values of all sub-field pixels of all “pre-corrected” sub-fields 804-808 of an image 802. Then, in a second part all shifts are applied for all sub-field pixels of all sub-fields “pre-corrected” 804-808 of an image. Followed by emission of light for the various “shifted” sub-fields 810-814.

to pre-correct partly and to store the values of all sub-field pixels of one particular “pre-corrected” sub-field, e.g. 804 of an image 802. Then, in a second part all shifts are applied for all sub-field pixels of the particular “pre-corrected” sub-field 804. Followed by emission of light for the particular “shifted” sub-field.

to pre-correct only a portion of the image 802 and to store the values of some sub-field pixels of one particular “pre-corrected” sub-field 804 of a portion of the image 802. Then, in a second part shifts are applied for some sub-field pixels of that sub-field 804. The result of the shift operation is buffered. After having processed a complete sub-field, e.g. 810 this will be followed by emission of light for that sub-field 810.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. An image processing unit (600) for processing pixels of an image to be displayed on a display panel (706) in a plurality of sub-fields, each of the sub-fields having a respective weight corresponding with a respective intensity level generated in this sub-field, the image processing unit comprising a motion compensation unit (617) designed to assign a value of a particular sub-field of a first pixel to a second pixel based on a first motion vector of the first pixel and on a first time difference between a first time of the particular sub-field and a reference time, characterized in that the image processing unit further comprises:
a first intensity calculating means (608) for calculating a contribution of a current sub-field to the first pixel on the basis of the first motion vector and the weight of the current sub-field; and
a decision means (614) for deciding whether the first pixel is to be ignited in the current sub-field on the basis of a target intensity level and the contribution of the current sub-field.

2. An image processing unit (600) as claimed in claim 1, characterized in further comprising:
a first storing means (602) for storing a desired intensity level of the first pixel;
a second intensity calculating means (612) for calculating an accumulated intensity level based on earlier processed sub-fields, if any; and
a third intensity calculating means (616) for calculating the target intensity level to be generated in the current and subsequent sub-fields, if any, on the basis of the accumulated intensity level and the desired intensity level.

3. An image processing unit (600) as claimed in claim 1, characterized in being arranged to process the sub-fields in order of decreasing weight of the sub-fields.

4. An image processing unit (600) as claimed in claim 1, characterized in being arranged to process only a portion of the sub-fields.

5. An image processing unit (600) as claimed in claim 1, characterized in that the first intensity calculating means (608) is arranged to calculate the contribution of the current sub-field to the first pixel by determining a pixel coverage of the first pixel based on:
a first offset (424) between a distance in first direction and a rounded distance in first direction, with the distance in first direction based on a second motion vector of the first pixel and on a second time difference between a current time of the current sub-field and the reference time; and
a second offset (422) between a distance in second direction and a rounded distance in second direction, with the distance in second direction based on the second motion vector of the first pixel and on the second time difference between the current time of the current sub-field and the reference time,
the first direction cross to the second direction.

6. An image processing unit (601) as claimed in claim 5, characterized in that the first intensity calculating means (608) is arranged to determine the pixel coverage of the first pixel by means of a Look-Up Table (610).

7. An image processing unit (601) as claimed in claim 1, characterized in that the decision means (614) is arranged to take into account decisions made for neighboring pixels.

8. An image processing unit (603) as claimed in claim 1, characterized in that the decision means (614) is arranged to select a sub-field combination out of a set of possible sub-field combinations in order to decide whether the first pixel is to be ignited in the current sub-field.

9. An image processing unit (605) as claimed in claim 1, characterized in that the image processing unit is designed to take into account constraints related to simultaneously addressing neighboring pixels of the display panel (706) with equal data.

10. A method of processing pixels of an image to be displayed on a display panel in a plurality of sub-fields, each of the sub-fields having a respective weight corresponding with a respective intensity level generated in this sub-field, the method comprising a motion compensation step of assigning a value of a particular sub-field of a first pixel to a second pixel based on a first motion vector of the first pixel and on a first time difference between a first time of the particular sub-field and a reference time, characterized in that the method further comprises:
a first intensity calculating step of calculating a contribution of a current sub-field to the first pixel on the basis of the first motion vector and the weight of the current sub-field; and
a decision step of deciding whether the first pixel is to be ignited in the current sub-field on the basis of a target intensity level and the contribution of the current sub-field.

11. A method as claimed in claim 10, characterized in that the method further comprises:
a storage step of storing a desired intensity level of the first pixel;
a second intensity calculating step of calculating the accumulated intensity level based on earlier processed sub-fields, if any; and
a third intensity calculating step of calculating a target intensity level to be generated in the current and subsequent sub-fields, if any, on the basis of the accumulated intensity level and the desired intensity level.

12. A method as claimed in claim 10, characterized in that the sub-fields are processed in order of decreasing weight of the sub-fields.

13. A method as claimed in claim 10, characterized in that only a portion of the sub-fields are processed.

14. A method as claimed in claim 10, characterized in that in the first intensity calculating step the contribution of the current sub-field to the first pixel is calculated by determining a pixel coverage of the first pixel based on:
a first offset between a distance in first direction and a rounded distance in first direction, with the distance in first direction based on a second motion vector of the first pixel and on a second time difference between a current time of the current sub-field and the reference time; and
a second offset between a distance in second direction and a rounded distance in second direction, with the distance in second direction based on the second motion vector of the first pixel and on the second time difference between the current time of the current sub-field and the reference time,
the first direction cross to the second direction.

15. An image display apparatus (700) for displaying a series of images, comprising:
receiving means (702) for receiving a signal representing the series of images;
an image processing unit (600) for processing pixels of an image to be displayed on a display panel in a plurality of sub-fields, each of the sub-fields having a respective weight corresponding with a respective intensity level generated in this sub-field, the image processing unit comprising a motion compensation unit designed to assign a value of a particular sub-field of a first pixel to a second pixel based on a first motion vector of the first pixel and on a first time difference between a first time of the particular sub-field and a reference time; and
the display panel for displaying the series of images, characterized in that the image processing unit further comprises:
a first intensity calculating means (608) for calculating a contribution of a current sub-field to the first pixel on the basis of the first motion vector and the weight of the current sub-field; and
a decision means (614) for deciding whether the first pixel is to be ignited in the current sub-field on the basis of a target intensity level and the contribution of the current sub-field.

16. An image display apparatus (700) as claimed in claim 15, characterized in that the image processing unit further comprises:
a first storing means (602) for storing a desired intensity level of the first pixel;
a second intensity calculating means (612) for calculating an accumulated intensity level based on earlier processed sub-fields, if any; and
a third intensity calculating means (616) for calculating the target intensity level to be generated in the current and subsequent sub-fields, if any, on the basis of the accumulated intensity level and the desired intensity level.

17. An image display apparatus (700) as claimed in claim 15, characterized in that the first intensity calculating means is arranged to calculate the contribution of the current sub-field to the first pixel by determining a pixel coverage of the first pixel based on:
a first offset (424) between a distance in first direction and a rounded distance in first direction, with the distance in first direction based on a second motion vector of the first pixel and on a second time difference between a current time of the current sub-field and the reference time; and
a second offset (422) between a distance in second direction and a rounded distance in second direction, with the distance in second direction based on the second motion vector of the first pixel and on the second time difference between the current time of the current sub-field and the reference time,
the first direction cross to the second direction.
